(19) United States
(12) Patent Application Publication
(10) Pub. No.: US 2026/0330607 A1
(43) Pub. Date: Oct. 22, 2026

(54) MULTIMODAL IMAGE RESTORATION

(71) Applicant: Google LLC, Mountain View, CA (US)

(72) Inventors: Mauricio Delbracio, Sunnyvale, CA (US); Kangfu Mei, Mountain View, CA (US); Hossein Talebi, San Jose, CA (US); Mojtaba Sahraee Ardakan, San Francisco, CA (US); Peyman Milanfar, Menlo Park, CA (US)

(21) Appl. No.: 19/556,769

(22) Filed: Mar. 4, 2026

Related U.S. Application Data
(60) Provisional application No. 63/766,938, filed on Mar. 4, 2025.

(51) Int. Cl. G06T 5/60; G06T 5/70; G06T 7/11; G06T 7/13; G06T 7/50

(52) U.S. Cl. CPC G06T 5/60; G06T 5/70; G06T 7/11; G06T 7/13; G06T 7/50; G06T 2207/20084

(57) ABSTRACT

This specification describes techniques, systems, and methods for using a diffusion neural network conditioned on multiple modalities of the input image to perform an image restoration task.

### CROSS-REFERENCE TO RELATED APPLICATIONS

This application claims priority to U.S. Provisional Application No. 63/766,938, filed on Mar. 4, 2025. The disclosure of this prior application is considered part of and is incorporated by reference in this disclosure of this application.

### BACKGROUND

This specification relates to image restoration.

Image restoration is the process of improving or reconstructing an image that has been degraded or corrupted. The goal is to restore the image to its original state or create the most accurate representation of the original scene.

Image restoration may be performed using neural networks.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, e.g., the next hidden layer or the output layer. Each layer of the network generates an output from a received input in accordance with current values of a respective set of parameters.

### SUMMARY

This specification describes a system implemented as computer programs on one or more computers in one or more locations that uses a diffusion neural network to perform an image restoration task on an input image. More specifically, the diffusion neural network can utilize multiple modalities of data associated with the input image to generate a restored image.

Generally, performing “image restoration” refers to recovering details, e.g., pixel level details, from a degraded image while preserving the original semantic information in the degraded image. In other words, image restoration tasks remove degradation from a degraded image to generate a restored image. Different image restoration tasks can remove different types of degradation from a degraded image.

Particular embodiments of the subject matter described in this specification can be implemented so as to realize one or more of the following advantages.

Image restoration tasks remain difficult due to the inherent difficulty of recovering fine grained details and preserving perceptual quality from low-resolution inputs. The image restoration system described in this specification leverages the rich contextual information available in multiple modalities of the input image to help generate a restored image, mitigating hallucinations by using spatial information from the multiple modalities to guide conditioning of the model. By conditioning the diffusion model on multiple modalities, e.g., including text captions and one or more spatial modalities, the image restoration system is able to, during restoration, implicitly align text captions with spatial modalities for correctly prompting different regions to enhance and preserve semantic identity and texture details in the restored image.

Moreover, by making use of the described techniques, the image restoration system is able to effectively fuse these multimodal modalities without requiring significant modifications to the existing diffusion process, resulting in minimal model size overhead.

Furthermore, in some cases, the image restoration system is able to control each modality's guidance strength to allow for more fine-grained manipulation of the restored image while preserving realism and quality of the image.

The details of one or more implementations of the subject matter described in this specification are set forth in the accompanying drawings and the description below.

Other potential features, aspects, and advantages of the subject matter will become apparent from the description, the drawings, and the claims.

### BRIEF DESCRIPTION OF THE DRAWINGS

FIG. 1 is a block diagram of an example image restoration system.

FIG. 2 shows an example input and output of an image restoration neural network.

FIG. 3 is a block diagram of an example image restoration process using a multi-modal token processing neural network and an image restoration neural network.

FIG. 4 shows an example multi-modal token processing neural network.

FIG. 5 illustrates the visual difference in the restored images of the image restoration neural network and other image restoration models.

FIG. 6 shows the quantitative differences between the image restoration neural network and other image restoration methods.

FIG. 7 is a flow diagram of an example process for performing an image restoration task using an image restoration neural network and multiple modalities of an input image.

Like reference numbers and designations in the various drawings indicate like elements.

### DETAILED DESCRIPTION

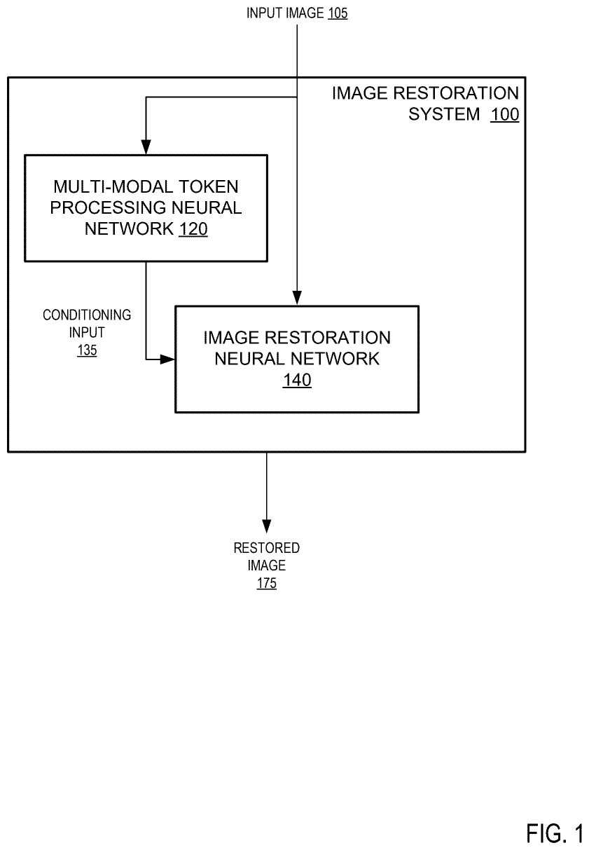

FIG. 1 is a block diagram of an example image restoration system.

The image restoration system 100 is an example of a system implemented as computer programs on one or more computers in one or more locations, in which the systems, components and techniques described below can be implemented.

The image restoration system 100 can receive as input an input image 105 and perform, using an image restoration neural network 140, an image restoration task to output a restored image 175.

The image restoration task can be any appropriate image restoration task.

For example, the image restoration task can be super resolution. In this example, the restored image 175 can be an image with a higher resolution than the input image 105.

As another example, the image restoration task can be denoising. Image noise is a random variation in an image's brightness or color information that can for example appear as grainy or speckled artifacts. In this example, the restored image 175 can be an image that has removed noise from the input image 105.

As another example, the image restoration task can be deblurring. The deblurring task can be a motion deblurring or a defocus deblurring task. Motion blur is a visual effect that occurs when a moving object is captured by a camera or other recording device while the object is still moving. The motion blur in an image of a moving object can appear as a blur or streaking effect. Defocus blur is a loss of sharpness in an image that occurs when an object is not positioned at the camera's focal plane, causing light rays from that object to spread out on the image sensor, resulting in a blurred appearance. For deblurring tasks, the restored image 175 can be an image that has restored one or more blurring artifacts in the input image 105.

As another example, the image restoration task can be inpainting. In this example, the restored image 175 can be an image that has filled in one or more missing or damaged areas of the input image 105.

To perform an image restoration task on an input image 105, the system 100 can receive the input image 105 and extract multiple modalities from the input image 105. The system 100 can then perform the image restoration task using the multiple extracted modalities.

More specifically, the image restoration system 100 can condition the image restoration neural network 140 on the extracted modalities by generating a conditioning input 135 from the extracted modalities using a multi-modal token processing neural network 120.

In other words, the image restoration system 100 can integrate additional modalities into its processing to provide detailed spatial context to align a textual description of an image with individual components, e.g., pixels and/or regions, of the image.

For example, the image restoration system 100 can receive the input image 105 from a user or can receive data identifying a resource locator or other identifier for the input image 105 from the user.

The image restoration system 100 can obtain, for each of multiple modalities, a context input belonging to the modality and characterizing the input image from the input image 105 on which to condition the image restoration neural network 140. The multiple modalities can be any appropriate modality that relates to an image. For example, the multiple modalities can include a text modality, and one or more spatial modalities. A text modality can represent textual content that is either embedded in or associated with an image. A spatial modality can represent visual content and/or information contained within the image, e.g., visual elements within the image. In some implementations, two or more of the modalities are different spatial modalities. For example, the spatial modalities can include one or more of: a depth modality, a segmentation modality, an edge modality, a pose modality, or any other appropriate spatial modality.

The system 100 can obtain the context input of the modality using any appropriate method given the modality. For example, the system 100 can use one or more image processing neural networks to obtain the context inputs of the respective modalities. As another example, the system 100 can receive the one or more context inputs of the respective modalities from the user.

For example, the context input of the text modality is a text prompt describing (i) the input image 105, (ii) the restored image 175, or (iii) both. In some implementations, the system 100 can receive the text prompt from the user. In some implementations, the system 100 can obtain the text prompt by processing the input image 105 using an image captioning neural network to generate the text prompt. As an example, the context inputs of the spatial modalities can include a context input of a segmentation modality, e.g., a segmentation map over the input image 105. The segmentation map can be any appropriate segmentation map, including a semantic segmentation map, an instance segmentation map, or a panoptic segmentation map. In some implementations, the image restoration system 100 can process the input image 105 using an image segmentation neural network to generate the segmentation map.

As an example, the context inputs of the spatial modalities can include a context input of an edge modality, e.g., an edge detection map that identifies edges in the input image 105. In some implementations, the image restoration system 100 can process the input image 105 using an edge detection neural network to generate the edge detection map.

As an example, the context inputs of the spatial modalities can include a context input of a depth modality, e.g., a depth map over the input image 105. In some implementations, the system 100 can process the input image 105 using a depth estimation neural network to generate the depth map.

The context inputs of the spatial modalities can characterize the spatial properties of the image by spatial regions, or per-pixel based on the desired level of granularity. That is, in some implementations, the context inputs of the spatial modalities include a respective set of one or more values for each of one or more spatial regions in the input image 105. For example, for the segmentation modality, the context input can be a segmentation map, where each spatial region is assigned a specific category, e.g., “lion”, “tongue”, “vegetation”, etc. In some implementations, the context inputs of the spatial modalities include a respective set of one or more values for each pixel of one or more pixels in the input image 105. For example, for the spatial modality, the context input can be a per pixel segmentation map, where each pixel is assigned a specific category, e.g., “lion”, “tongue”, “vegetation”, etc.

The image restoration system 100 can process the context inputs of the multiple modalities of the input image 105 using a multi-modal token processing neural network 120 to generate a conditioning input 135 for the image restoration neural network 140. More specifically, the multiple modalities, e.g., text modality and one or more spatial modalities, can each be encoded into a set of tokens representing the respective context input of the modality by one or more encoder neural networks and then processed by the multi-modal token processing neural network 120.

The one or more encoder neural networks can be any appropriate encoder neural networks.

In some implementations, the image restoration system 100 can include a single encoder neural network that is configured to encode multiple modalities, including a text modality and one or more spatial modalities characterizing an image, into sets of tokens where each set of tokens represents a context input of a modality.

In some implementations, the image restoration system 100 can include one or more encoder neural networks to encode the multiple modalities. For example, the system 100 can include a first encoder neural network for encoding a context input for the text modality and a second encoder neural network for encoding the one or more spatial modalities characterizing the image. As a specific example, the system 100 can include a contrastive-learning encoder for the context input of the text modality, e.g., a text prompt, and a spatial modality encoder for the context inputs of the one or more spatial modalities.

In some implementations, the image restoration system 100 can include a respective encoder neural network for each of the multiple modalities. For example, the image restoration system 100 can include a first encoder neural network for encoding a context input for the text modality, a second encoder neural network for encoding a context input for the segmentation modality, a third encoder neural network for encoding a context input for the depth modality, and a fourth encoder neural network for encoding a context input for the edge modality.

The multi-modal token processing neural network 120 can process the sets of tokens for the modalities to generate a set of multi-modal tokens that serves as a conditioning input 135 for the image restoration neural network 140.

The multi-modal token processing neural network 120 can process the sets of tokens for the modalities by applying one or more operations to the sets of tokens. For example, the multi-modal token processing neural network 120 can apply a cross attention mechanism between the sets of tokens for the modalities and a sequence of learnable latent tokens to generate a set of multi-modal tokens, which serve as the conditioning input 135 for the image restoration model 140. In some implementations the multi-modal token processing neural network 120 can perform additional operations before generating the set of multi-modal tokens.

The multi-modal token processing neural network 120 can have any appropriate neural network architecture. For example, the multi-modal token processing neural network 120 can have a Transformer neural network architecture.

The image restoration neural network 140 can receive the conditioning input 135, e.g., the set of multi-modal tokens from the multi-modal token processing neural network 120, and process the conditioning input 135 along with the input image 105 to generate a restored image 175.

The image restoration neural network 140 can be any appropriate image restoration neural network with any appropriate neural network architecture that is configured to receive an input image and perform an image restoration task to generate a restored image.

For example, the image restoration neural network 140 can be a diffusion neural network (also referred to as a “denoising” neural network).

The image restoration neural network 140 can be any appropriate diffusion neural network that is configured to receive an input that includes a current (noisy) representation of an image, e.g., a degraded image, and a conditioning input and to generate a denoising output.

In some implementations, the diffusion neural network performs a diffusion process in output space, e.g., pixel space when the data items are images. In this example, when the data items are images, the data items (“representations”) operated on and generated by the diffusion neural network have values for each pixel that specify color values, e.g., RGB values or another color encoding scheme.

Examples of such diffusion neural networks include Imagen.

In some other implementations, the diffusion neural network performs a diffusion process in latent space, e.g., in a latent space that is lower-dimensional than the output space. That is, the data items (“representations”) operated on by the diffusion neural network are latent representations and the values in the representations are learned, latent values, e.g., rather than color values when the data items are images. The diffusion neural network can be associated with or include an encoder neural network to encode images into the latent space and a decoder neural network that receives an input that includes a latent representation of an image and decodes the latent representation to reconstruct the image.

Examples of such diffusion neural networks include mobile diffusion.

In these implementations, after training, the diffusion neural network can be associated with a decoder neural network that receives an input that includes a latent representation of the final data item and decodes the latent representation to reconstruct the data item.

In some implementations, the diffusion neural network can be a convolutional neural network, e.g., a U-Net or other architecture that maps one input of a given dimensionality to an output of the same dimensionality.

As another example, the diffusion neural network can be a Transformer neural network that processes the diffusion input through a set of self-attention layers to generate the denoising output.

As yet another example, the diffusion neural network can include both convolutional layers and self-attention layers.

The multi-modal token processing neural network 120 and the image restoration neural network 140 of the image restoration system 100 can be trained jointly to generate a restored image 175 from a conditioned image restoration neural network 140.

The one or more encoder neural networks can be pre-trained encoder neural networks. The one or more encoder neural networks can be pre-trained based on the multiple modalities for the one or more encoders. For example, for a first encoder neural network for encoding a context input for the text modality and a second encoder neural network for encoding the one or more spatial modalities characterizing the image, the first encoder neural network can be pretrained on one or more datasets that include one or more training examples, where a training example includes (i) an image, and (ii) a ground-truth text description and the second encoder neural network can be pretrained on one or more multimodal datasets including one or more training examples, where each training example includes (i) an image, (ii) a ground-truth segmentation map, (iii) a ground-truth depth map and (iv) a ground-truth edge detection map.

As another example, for a first encoder neural network for encoding a context input for the text modality, a second encoder neural network for encoding a context input for the segmentation modality, a third encoder neural network for encoding a context input for the depth modality, and a fourth encoder neural network for encoding a context input for the edge modality, the one or more encoders can be pretrained on one or more respective datasets including one or more training examples, where a training example includes (i) an image and (ii) a ground-truth modality. For example, the first encoder neural network can be pretrained on one or more datasets including one or more training examples, where a training example includes (i) an image, and (ii) a ground-truth text description, the second encoder neural network can be pretrained on one or more datasets including one or more training examples, where a training example includes (i) an image, and (ii) a ground-truth segmentation map, the third encoder neural network can be pretrained on one or more datasets including one or more training examples, where a training example includes (i) an image, and (ii) a ground-truth depth map, and the fourth encoded neural network can be pretrained on one or more datasets including one or more training examples, where a training example includes (i) an image, and (ii) a ground-truth edge detection map.

The one or more encoders can generate, based on the one or more training datasets, a training output and be pretrained on the generated training outputs using a loss function. More specifically, the loss function can compare the generated training output with the ground truth value of the modality in the training example of the one or more datasets, e.g., the ground-truth text description, segmentation map, edge detection map and depth map. The loss function can be any appropriate loss function, including a reconstruction loss, an adversarial loss, a contrastive loss, depending on the one or more encoders and the multiple modalities of the encoder. The one or more encoders can then be pretrained to minimize the loss function by computing a gradient of the loss function with respect to the parameters of the respective encoder, e.g., through backpropagation. The training system can then apply an optimizer to the gradients to update the parameters of the encoder, such as Adafactor and Adam, SGD and so on.

The image restoration system 100 can be trained to perform any image restoration task conditioned on a set of multi-modal tokens. The image restoration system 100 can be trained on a set of training examples that include (i) a degraded image, and (ii) a ground truth restored image that is a restored version of the degraded image. For example, for a super resolution task, the image restoration system 100 can be trained on a set of training examples that include (i) a randomly degraded low resolution image, and (ii) the corresponding ground truth high resolution image.

In some implementations, the image restoration system 100 can be trained on a set of training examples that include (i) a degraded image, (ii) a set of multi-modal tokens that represent the modalities of the degraded image, and (iii) a ground truth restored image.

The image restoration system 100 can be trained to receive the degraded image as input, generate a set of multi-modal tokens, and then generate a restored image from the degraded input and the set of multi-modal tokens. The image restoration system 100 can train the multi-modal token processing neural network 120 and the image restoration neural network 140 on the one or more training examples to generate a restored image on a denoising objective or other appropriate diffusion model training objectives.

To begin an iteration of the training process, the image restoration system 100 can sample one or more of the training examples.

The below steps can be implemented for each of the one or more sampled training examples.

In implementations in which the set of training examples includes (i) the degraded image, and (ii) the ground truth restored image that is a restored version of the degraded image, and does not include (iii) the set of multi-modal tokens that represent the modalities of the degraded image, the one or more encoders and the multi-modal token processing neural network 120 can be used to generate the set of multi-modal tokens. That is, the one or more encoders, frozen during training of the image restoration system 100, can receive the sampled training example and encode the multiple modalities e.g., the text modality and the one or more spatial modalities, of the degraded image into one or more sets of tokens representing the respective context input of the modality. The multi-modal token processing neural network 120 can receive the one or more sets of tokens representing the context inputs and process the set of tokens to generate the set of multi-modal tokens that represents the modalities, or the conditioning input.

The image restoration neural network can receive the set of multi-modal tokens and the degraded image and can generate a noisy representation of the restored image in the training example. For example, noise can be added to an initial representation of the restored image. To generate the noisy representation of the restored image, the image restoration system 100 can randomly sample noise, e.g., Gaussian noise, to be added to the restored image. The image restoration system 100 can randomly sample a noise level and combine the initial representation of the restored image and the noise in accordance with the noise level.

The initial representation of the restored image can be generated using an encoder when the diffusion process occurs in the latent space, or the restored image can be used as the initial representation when the diffusion process occurs in the pixel space.

The image restoration neural network can then process a diffusion input that includes (i) the noisy representation of the restored image, (ii) a representation of the ground-truth restored image, and (iii) a representation of the set of multi-modal tokens to generate a denoising output that defines an update to the noisy representation of the restored image. For example, the denoising output can be an estimate of the noise component of the noisy representation of the restored image.

The image restoration system 100 can train the multi-modal token processing neural network 120 and the image restoration neural network 140 on an objective that measures an error between, the denoising output, e.g. an estimate of the noise, and the actual noise added to the initial representation of the restored image.

The error can be any appropriate error measurement or metric. For example, the model can calculate a mean-squared error estimate between the denoising output and the noisy representation of the degraded image to train the multi-modal token processing neural network and the image restoration neural network. The image restoration system 100 can train the multi-modal token processing neural network 120 and the image restoration neural network 140 by computing a gradient of the error with respect to the parameters of the multi-modal token processing neural network 120 and the image restoration neural network 140, e.g., through backpropagation. The image restoration system 100 can then apply an optimizer to the gradients to update the parameters of the models. The system 100 can use any appropriate optimizer to train the neural networks, e.g., Adam, Adafactor, SGD, and so on.

In some implementations, the image restoration model 140 can be initialized with the weights of a pretrained image restoration model and fine-tuned over the set of training examples as described above.

In some implementations, during training, the multi-modal token processing neural network 120 can be trained to handle missing modalities. For example, a multi-modal token processing neural network 120 can be trained to generate a set of multi-modal tokens that includes a set of tokens for a text modality, a set of tokens for a segmentation modality, a set of tokens for a depth modality, and a set of tokens for an edge modality. In some implementations, the system 100 cannot extract a context input for each of the aforementioned modalities. To encourage the model to learn robust representations that can effectively handle missing information, e.g., a missing set of tokens for a modality, during training, the system 100 can randomly and independently replace each modality with a set of learnable tokens. That is, the system 100 can randomly replace a segmentation modality with a set of learnable tokens in a first training iteration, an edge modality with a set of learnable tokens in a second training iteration, etc., such that the system 100 learns to effectively handle missing information for each modality.

In some implementations, the multi-modal token processing neural network 120 and the image restoration neural network 140 can be trained separately.

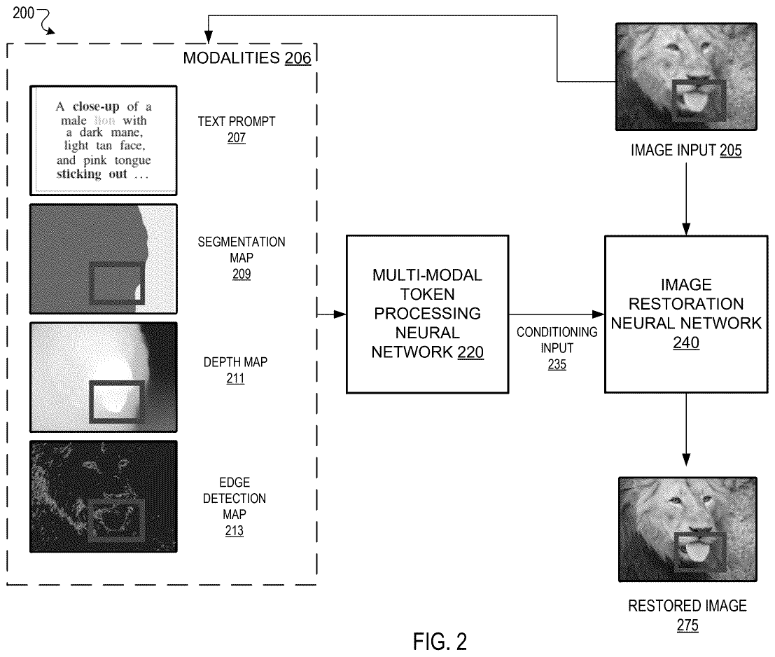

FIG. 2 shows an example input and output of an image restoration system, e.g., the image restoration system 100 of FIG. 1.

As described above, the image restoration system 100 can perform any of a variety of image restoration tasks. For example, as illustrated in FIG. 2, the image restoration system 100 can perform a super-resolution task on a low resolution input image 205 to generate a high resolution image 275.

As a specific example, the image restoration system 100 can restore an image of a lion with its tongue sticking out. As highlighted in the input image 205 and the restored image, 275, the image restoration 100 is able to restore the lion's tongue with a highly realistic texture.

To perform the image restoration task, the image restoration system 100 can receive the image input 205. For example, the image input 205 is a low resolution image, e.g., grainy and unfocused, of a lion with its tongue sticking out.

The image restoration system 100 can obtain a context input belonging to a modality of multiple modalities and characterizing the input image 205. For example, the image restoration system 100 can obtain a context input for each of a text modality, a segmentation modality, a depth modality, and an edge modality from the input image 205. As an example, the context input of the text modality can be a text prompt 207 describing the input image 205 and the restored image 275 that states “A close-up of a male lion with a dark mane, a light tan face, and pink tongue sticking out . . . ” As an example, the context input of the segmentation modality can be a semantic segmentation map 209 of the input image 205 that segments (or partitions) the input image 205 into multiple segments or regions. For example, the segmentation map 209 segments the image into the background and the lion. As an example, the context input of the depth modality can be a depth map 211 of the image that captures the 3D structure of the lion in more detail. As an example, the context input of the edge modality can be an edge detection map 213 of the image that highlights the edges within the input image 205. For example, the edge detection map highlights the boundaries between different regions of the lion where there are significant changes in color and/or intensity.

The image restoration system 100 can process the context inputs of the multiple modalities 206 using a multi-modal token processing neural network 220 to generate a conditioning input 235, e.g., a set of multi-modal tokens representing the multiple modalities, on which to condition the image restoration neural network 240.

The image restoration neural network 240 can receive the conditioning input 235 and the input image 205 as input and generate the restored image 275.

For example, the image restoration neural network 240 can receive a conditioning input 235 that is a compressed representation of the multiple modalities 206 and generate a restored image 275 of a lion with its tongue sticking out.

The restored image 275 can be a higher resolution, e.g., clearer and in focus, image of the lion with a (realistic) tongue sticking out.

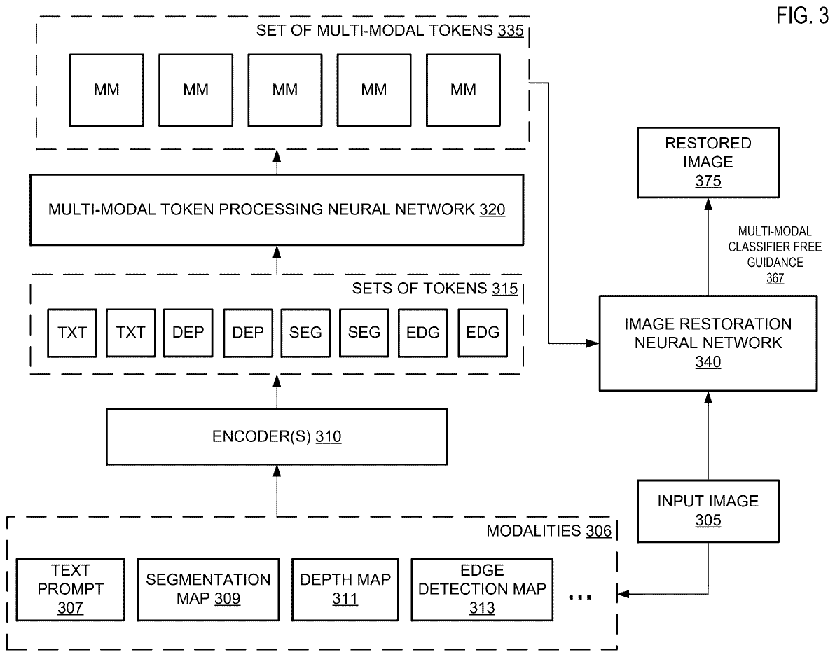

FIG. 3 is a block diagram of an example image restoration process using an example image restoration system, e.g., the image restoration system 100 of FIGS. 1 and 2.

The image restoration system 100 can include a multi-modal token processing neural network 320 and an image restoration neural network 340.

To perform an image restoration process, the image restoration system 100 can receive an input image 305 and obtain from the multiple modalities 306, a respective context input belonging to the modality and characterizing the input image 305. For example, for input image 305, the image restoration system can obtain a context input for each of a (i) text modality, (ii) a segmentation modality, (iii) a depth modality, and (iv) an edge modality.

For example, the context inputs for the modalities 306 can include a text prompt 307, a segmentation map 309, a depth map 311, and an edge detection map 313.

The image restoration system 100 can perform an image restoration task on the input image 305 by generating a restored image 375 using an image restoration neural network 340 that is conditioned on the extracted context inputs for the multiple modalities 306.

More specifically, the image restoration system 100 can process the respective context inputs for the multiple modalities 306 to generate a conditioning input and generate the restored image 375 from the input image 305 by processing the input image 305 and the conditioning input using the image restoration neural network 340.

The image restoration system 100 can process the respective context inputs for the multiple modalities 306 using one or more encoders 310 and the multi-modal token processing neural network 320 to generate a set of multi-modal tokens 335 that acts as the conditioning input for the image restoration neural network 340.

The image restoration system 100 can utilize one or more encoders 310 to encode each of the multiple modalities 306 into a set of tokens that includes one or more modality tokens characterizing the context input of the respective modality. For example, the context inputs for the four modalities, e.g., text, segmentation, depth, and edge, can be encoded into four respective sets of tokens: one set of tokens representing the text prompt 307, one set of tokens representing the segmentation map 309, one set of tokens representing the depth map 311, and one set of tokens representing the edge detection map. Each set of tokens can include one or more tokens representing the context input for the respective modality. For example, the sets of tokens 315 can include four sets of tokens with each set of tokens including two tokens for each context input: two tokens representing the text prompt 307, two tokens representing the segmentation map 309, two tokens representing the depth map 311, and two tokens representing the edge detection map 313.

In some implementations, the encoder(s) 310 can be a contrastive-learning encoder and a spatial modality encoder. For example, the contrastive-learning encoder can generate the set of tokens representing the text prompt 307 and the spatial modality encoder can generate the set of tokens for each of the context inputs of the spatial modalities, e.g., the segmentation map 309, the depth map 311, and the edge detection map 313. The contrastive learning encoder can map natural language descriptions and visual features into a shared, unified latent space. By maximizing the similarity between corresponding image-text pairs, the contrastive learning encoder can enable the image restoration system 100 to transform abstract textual context into high-dimensional token embeddings that an image restoration neural network 340 can use to identify and reconstruct specific semantic identities. The spatial modality encoder can map multi-channel structural data-such as depth, segmentation, or edge detection maps-into a sequence of discrete tokens. By utilizing a learned codebook of visual primitives, the spatial modality encoder can preserve fine-grained pixel-level details and spatial relationships that are essential for accurate image reconstruction. This quantization process ensures that complex geometric information is standardized into a unified format, allowing the image restoration neural network 340 to process diverse structural inputs with consistent efficiency.

The multi-modal token processing neural network 320 can receive the sets of tokens 315 as input and generate a set of multi-modal tokens 335 that serves as the conditioning input for the image restoration neural network 340.

The multi-modal token processing neural network 320 can process the sets of tokens 315 by applying one or more operations to the set of tokens 315. For example, the multi-modal token processing neural network 120 can apply a cross-attention mechanism between the sets of tokens and a sequence of learnable latent tokens to generate a token sequence of the same length as the latent token sequence, e.g., the set of multi-modal tokens 335. In some implementations, the multi-modal token processing neural network 320 can further apply one or more attention mechanisms, e.g., self-attention, before generating the final set of multi-modal tokens 335.

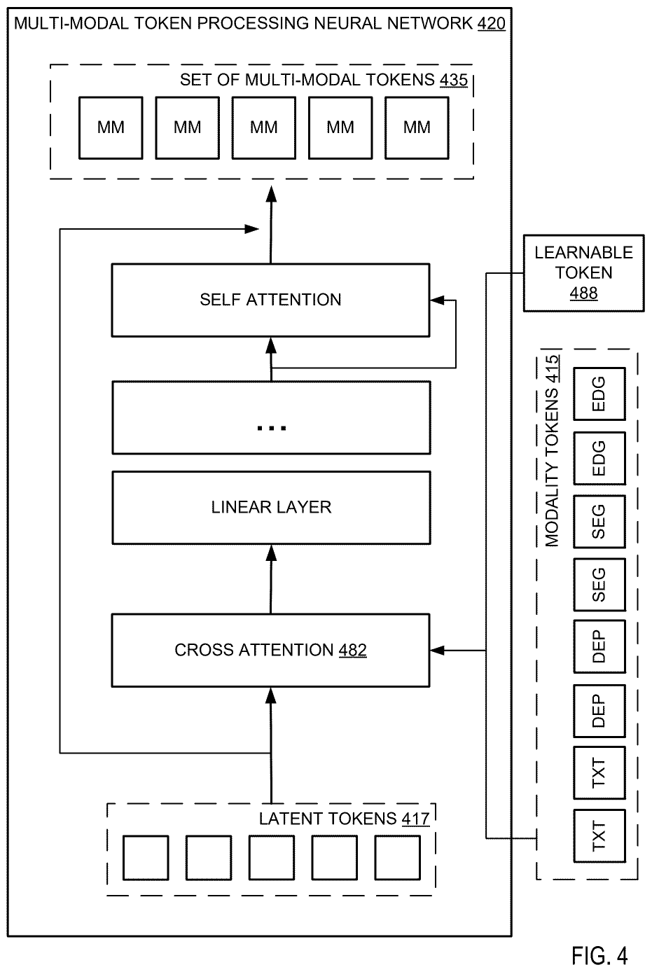

The multi-modal token processing neural network 320 is described in further detail below with reference to FIG. 4.

The image restoration neural network 340 can receive the conditioning input, e.g., the set of multi-modal tokens 335, from the multi-modal token processing neural network 320 and the input image 305 as input and process the input to generate a restored image 375.

The image restoration neural network 340 can process the input image 305 and the conditioning input 335 by performing a denoising process.

Prior to the one or more denoising steps, the image restoration system 100 can generate a representation of the input image 305. For example, the representation of the input image 305 can be a latent representation that is generated by processing the input image 305 using an encoder neural network. As another example, the representation of the input image 305 can be a pixel representation that uses the input image 305 as the initial representation.

To perform image restoration, the image restoration neural network 340 can initialize a representation of the restored image 375, e.g., generate an initial representation of the restored image that is then updated across one or more denoising steps using the image restoration neural network 340. The image restoration neural network 340 can initialize the representation of the restored image 375 by sampling each value in the representation from a noise distribution, e.g., a Gaussian noise distribution or other appropriate noise distribution.

At each of a sequence of denoising steps, the image restoration neural network 340 can process an input for the denoising step that includes (i) the current representation of the restored image 375, (ii) the representation of the input image 305, and (iii) the conditioning input, e.g., the set of multi-modal tokens 335, for the image restoration task using the image restoration neural network 340 to generate a denoising output for the denoising step that corresponds to the image restoration task.

The denoising output can define an estimate of the noise component of the representation as of the sampling iteration, i.e., of the noise that has been added to a ground truth representation of the ground truth restored image 375 to generate the representation.

Generally, the input can also include timestep data that defines a noise level for the current representation of the restored image 375. Each denoising step, e.g., updating iteration, has a corresponding time step t and the noise level for the denoising step depends on the time step. For example, the noise level can be a decreasing function of the time step t. Examples of such functions include a linear function, a cosine function, and a sigmoid function. In these cases, data identifying the noise level, the time step, or both can be embedded using an appropriate neural network, e.g., a multi-layer perceptron (MLP) and used to condition the diffusion neural network as described above for the conditioning input.

In some implementations, the image restoration neural network 340 can utilize a multi-modal classifier free guidance 367 process to enhance the denoising output. In particular, the classifier free guidance process can introduce a negative prompt that dictates undesirable or unwanted features in the restored image 375.

In classifier free guidance, generating the denoising output includes combining a first, or positive, denoising output with a second, or negative, denoising output, e.g., a classifier-free guidance output, which can be generated by the system 100 or another system. The image restoration neural network 340 can then compute the sum of the first and second denoising outputs with the weight for each denoising output being determined by a guidance weight for the classifier free guidance.

The first, or positive, denoising output can be generated from the above described process using a first input that includes the representation of the restored image 375, the representation of the input image 305, and the conditioning input, e.g., the set of multi-modal tokens 335, representing the positive text prompt. That is, the positive text prompt can be the context input of the text modality that is captured in the set of multi-modal tokens 335, e.g., the text prompt 307.

The second denoising output can be generated from the above described process using a second input into the image restoration neural network 340 that includes a negative text prompt as well as the representation of the restored image 375, the representation of the input image 305, and the conditioning input, e.g., the set of multi-modal tokens 335. That is, the negative prompt can dictate undesirable or unwanted features in the restored image 375. For example, the negative prompt for a degraded image of a lion sticking its tongue out can be “blurry, low quality, distorted face, closed mouth, dark lighting.” In some implementations, the image restoration system 100 can receive the negative text prompt from a user of the system 100.

The utilization of a negative prompt can help guide the image restoration neural network 340 to suppress unwanted features, e.g., to inform the neural network 340 on what is not wanted in the image, as compared to an empty prompt, which leads to an unconditioned prediction without any external influence, e.g., does not guide the model in a particular way. That is, classifier-free guidance with a positive and negative prompt can help guide the image restoration neural network towards generating a restored image that matches the positive prompt and avoids generating unwanted features as described in the negative prompt.

In some implementations, the image restoration neural network 340 can utilize multi-modal classifier free guidance 367 to guide the denoising process in generating the restored image 375. That is, the image restoration neural network 340 can leverage the rich information encoded in the set of multi-modal tokens 335 to strengthen both positive and negative prompts when generating the first and second denoising outputs.

More specifically, the image restoration system 100 can condition both the positive and negative generation processes on the set of multi-modal tokens, as seen below, where e denotes the diffusion model, zₜ denotes the noisy image representation, c denotes the conditioning input, w is the guidance weight, m is the set of multi-modal tokens 335, and pos and neg are the positive and negative prompts:

\tilde{ϵ}(zₜ,c,m)=(1+w)ϵ(zₜ,c,pos,m)−wϵ(zₜ,c,neg,m)

Overall, as seen in the above equation, the denoising output \tilde{ϵ}(zₜ, c, m) can be a combination of the first denoising output ϵ(zₜ, c, pos, m) and second denoising output ϵ(zₜ, c, neg, m) in accordance with a guidance weight. The guidance weight can be a fixed scalar used during the denoising of the degraded image and can be pre-configured or received from a user of the image restoration system 100.

The image restoration system can generate the denoising output for the denoising step by combining one or more denoising outputs generated by using the image restoration neural network 340 that correspond respectively to the one or more image restoration tasks, e.g., the first and second denoising outputs, and then update the current representation of the restored image 375 using the combined denoising output, e.g., by applying a diffusion sampler to the combined denoising output. For example, the image restoration neural network 340 can apply the DDPM (Denoising Diffusion Probabilistic Model) sampler, the DDIM (Denoising Diffusion Implicit Model) sampler or another appropriate sampler, to the initial updated representation to generate an updated representation restored image 375.

Optionally, after the last denoising step, the image restoration neural network 340 can refrain from using the diffusion sampler and can instead use the initial updated representation as the updated representation of the restored image 375.

In some implementations, the image restoration neural network 340 can determine an initial estimate of an updated representation of the restored image 375 from the denoising output that corresponds to the image restoration task, and then can combine the initial estimates determined for the one or more image restoration tasks to generate the updated latent representation.

When the denoising step is the first (initial) denoising step in the plurality of denoising steps, the current representation of the restored image 375 is the initial representation of the restored image 375. For any subsequent denoising step in the sequence of denoising steps, the current representation of the restored image 375 is an updated representation of the restored image 375 that has been generated in a preceding denoising step.

After the last denoising step in the sequence, the image restoration neural network 340 can generate the restored image 375 from the representation of the restored image.

In some implementations, the representation of the restored image is a representation in a latent space. The image restoration neural network 340 can generate the restored image 375 from the final representation of the restored image by processing the representation of the restored image using a decoder neural network.

In some implementations, the representation of the restored image is a representation in a pixel space. The system can use the final representation of the restored image as the restored image 375.

FIG. 4 shows an example multi-modal token processing neural network 420.

To generate the set of multi-modal tokens, the multi-modal token processing neural network 420 can process the sets of tokens 415 by applying one or more operations to the tokens.

The multi-modal token processing neural network 420 can receive as input the sets of tokens 415 and a sequence of learnable latent tokens 417.

In this disclosure, the sequence of learnable latent tokens 417 is a set of trainable vector representations that are learned directly during training, e.g., updated via backpropagation, and can be updated during inference via one or more operations. For example, the learnable latent tokens 417 can be updated via a cross attention mechanism 484 between the learnable latent tokens 417 and the sequence of modality tokens 415. In some implementations, the sequence of learnable latent tokens is randomly initialized before training.

The multi-modal token processing neural network 420 can process the input to generate a set of multi-modal tokens 435 that is the same length as the learnable latent tokens 417 that is used as the conditioning input of the image restoration neural network, e.g., the image restoration neural network 340 of FIG. 3. By conditioning the image restoration neural network on a fixed length token sequence that is significantly shorter than the sets of modality tokens 415, the image restoration system, e.g., the image restoration system 100 of FIG. 1, can significantly reduce the computational cost of cross-attention to efficiently process high-dimensional multimodal data.

The multi-modal token processing neural network 420 can process the input to generate a set of multi-modal tokens 435 by applying a cross-attention mechanism 482 between the sets of tokens 415 and the sequence of learnable latent tokens 417. The multi-modal token processing neural network 420 can distill the essential information from the longer sets of tokens 415 into a more compressed representation through cross attention with the learnable latent tokens 417.

The multi-modal token processing neural network 420 can perform a cross-attention mechanism between the sets of tokens 415 and the sequence of learnable latent tokens 417, as seen below, where Q is derived from the sequence of learnable latent tokens 417, and K and V are derived from the sets of tokens 415:

$$Attention ( Q , K , V ) = softmax ( \frac{Q {K}^{T}}{δ} ) V$$

The cross-attention mechanism 482 can further include a cross-attention temperature & that scales the attention maps before applying the softmax operation.

In some implementations, the contributions of specific modalities can be amplified or suppressed by modifying the attention temperature 8 of the multi-modal token processing neural network 420 during cross-attention. When the attention temperature is high, the attention distribution becomes softer, meaning that the multi-modal token processing model spreads its focus more evenly across all modalities, reducing the influence of any one modality. When the attention temperature is low, the attention distribution is sharper and the model focuses more intensely on specific modalities, amplifying their influence. That is, the influence of specific modalities can be amplified by decreasing the attention temperature of the modality when applying the cross-attention mechanism of the multi-modal token processing neural network 420 and the influence of any one modality of the multiple modalities can be suppressed by increasing the temperature of the modality when applying the cross attention mechanism of the multi-modal token processing neural network 420. The attention temperature of the modality can be pre-configured or set by the user of the image restoration system 100.

In some implementations, the multi-modal token processing neural network 420 can further apply one or more operations to the output of the cross-attention mechanism 482 between the sets of tokens 415 and the learnable latent tokens 417.

In some implementations, the multi-modal token processing neural network 420 can apply one or more operations of a linear neural network layer to the output of the cross-attention mechanism 482, e.g., an initial set of multi-modal tokens.

In some implementations, the multi-modal token processing neural network 420 can further apply an attention mechanism to the output of the cross-attention mechanism, e.g., an initial sequence of multi-modal tokens to generate the set of multi-modal tokens 435. In some implementations, the multi-modal token processing neural network 420 can apply a self-attention mechanism to the initial set of multi-modal tokens. In some implementations, the multi-modal token processing neural network 420 can include one or more self-attention blocks.

As described above with reference to FIG. 1, during training, the multi-modal token processing neural network 420 can be trained to handle scenarios where multiple modalities are unreliable or unavailable, e.g., one or more of the sets of tokens 415 is missing or unreliable. The multi-modal token processing neural network 420 can utilize a special learnable token 488 to represent the absence of a modality. During training, the image restoration system, e.g., the image restoration system 100 of FIG. 1, can independently randomly replace each modality with a number of special learnable tokens to encourage the model to learn robust representations that can effectively handle missing information. During inference, any missing modality can be represented by a sequence of learnable tokens 488.

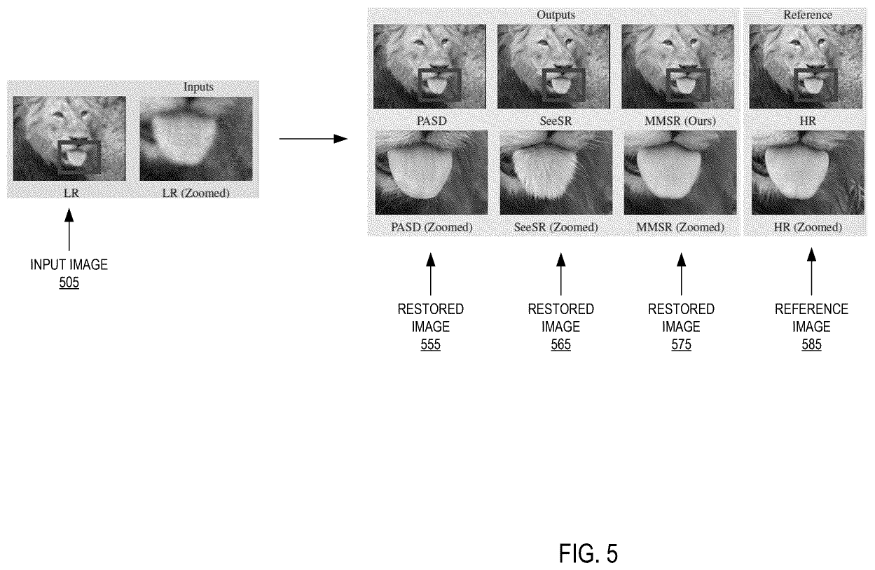

FIG. 5 illustrates the difference in the restored images of the image restoration neural network, e.g., the image restoration neural network 140 of FIG. 1, and other image restoration models compared to a reference image 585.

Each of the image restoration neural networks, including the image restoration neural network 140 described in this disclosure, were given a low resolution input image 505 of a lion with its tongue sticking out and performed a super-resolution task to generate a high-resolution restored image of the lion with its tongue sticking out. For example, the two other comparable image restoration models respectively generated restored image 555 and restored image 565, while the image restoration neural network 140 generated the restored image 575.

As seen in FIG. 5, the restored image 575 generated by the image restoration neural network 140 is the most realistic and accurate compared to the reference image 585. More specifically, when comparing the tongues of the lion in the reference image, the restored image 575 includes the tongue with the closest texture to the real tongue seen in the reference image 585. For example, the lions' tongue in restored image 555 has too smooth of a texture and the lion's tongue in restored image 565 has a furry texture. As evidenced by the furry texture, the restoration model that generated the restored image 565 has mistaken the furry texture of lion with the texture of the tongue of the lion when performing the super resolution task.

By conditioning the image restoration neural network 140 on multiple modalities of the input image, the image restoration neural network 140 can give the model more information to guide the restoration task and help generate more realistic-looking restored images.

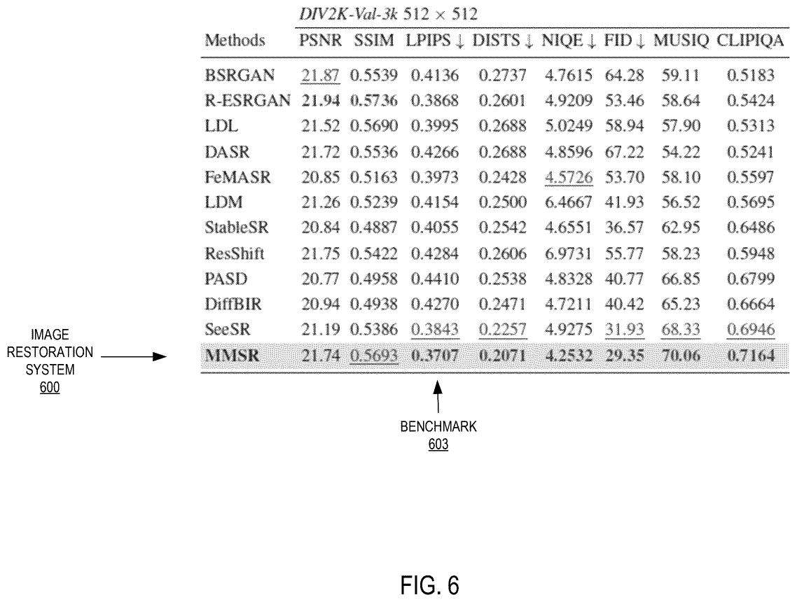

FIG. 6 shows the quantitative differences between the image restoration neural network and other image restoration methods across a variety of common metrics.

The table shows the quantitative result comparisons of the image restoration neural network, e.g., the image restoration neural network 140 of FIG. 1 described in this disclosure, with other state-of-the-art image restoration neural networks.

As seen in the table, the image restoration neural network 140 outperforms the other image restoration neural networks over six image restoration metrics: LPIPS, DISTS, NIQE, FID, MUSIQ, and CLIPIQA.

The learned perceptual image patch similarity (LPIPS) metric measures perceptual similarity between a restored image and a reference image in a way that aligns with human perception. For this metric, a lower score means there is less perceptual difference between the restored and the reference image. The restored image of the image restoration neural network 140 has the lowest LPIPS score as compared to the other state-of-the-art image restoration models.

The deep image structure and texture similarity (DISTS) metric measures structure and texture similarity of a restored image and a reference image. For this metric, a lower score means there is less structure and/or text difference between the restored and the reference image. The restored image of the image restoration neural network 140 has the lowest DISTS score as compared to the other state-of-the-art image restoration models.

The natural image quality evaluation (NIQE) metric measures image quality of a restored image, e.g., how natural an image looks. For this metric, a lower score means a more natural looking image. The restored image of the image restoration neural network 140 has the lowest NIQE score as compared to the other state-of-the-art image restoration models.

The frechet inception distance (FID) metric measures the quality of generated images by comparing the distribution of features between a restored image and a reference image. For this metric, a lower score means that the restored image is closer to the reference image in terms of the distribution of features in the image. The restored image of the image restoration neural network 140 has the lowest FID score as compared to the other state-of-the-art image restoration models.

The multi-scale image quality (MUSIQ) metric measures image quality by using a multi-scale vision transformer to predict perceptual quality. For this metric, a higher score means a higher predicted perceptual quality. The restored image of the image restoration neural network 140 has the highest MUSIQ score as compared to the other state-of-the-art image restoration models.

The CLIP base image quality assessment (CLIPIQA) metric uses a contrastive language image pretraining (CLIP) model to assess image quality by aligning image quality with human preferences and/or textual descriptions. For this metric, a higher score means a better alignment of the restored image with human perception and/or semantics. The restored image of the image restoration neural network 140 has the highest CLIPIQA score as compared to the other state-of-the-art image restoration models.

The image restoration neural network 140 can significantly outperform the previous state-of-the-art methods on all of the above mentioned image restoration/generation metrics. That is, the image restoration neural network 140 can generate more perceptually identical details from the guidance of multimodal content. The image restoration neural network 140 also achieves the best performance in the non-reference visual quality metrics, e.g., metrics that do not compare the restored image to a reference image. For example, non-reference visual quality metrics include NIQE, MUSIQ, and CLIPIQA. This demonstrates the ability of the image restoration neural network 140 to generate natural and realistic images and/or elements of images when restoring a degraded image.

Overall, the table quantitatively demonstrates the advantages in using multi-modal tokens to enrich the knowledge of the image restoration neural network 140 when performing an image restoration task.

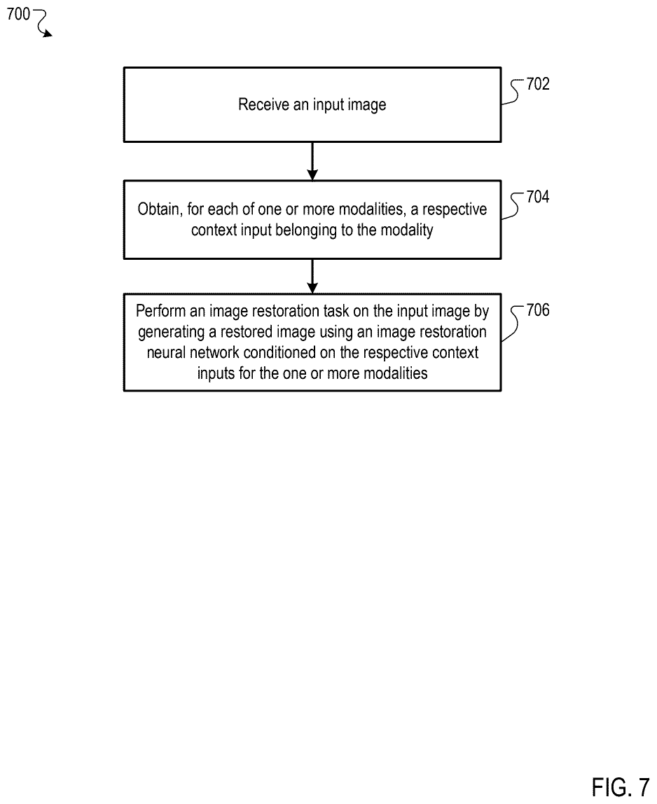

FIG. 7 is a flow diagram of an example process for performing an image restoration task using an image restoration neural network and multiple modalities of an input image.

For convenience, the process 700 will be described as being performed by a system of one or more computers located in one or more locations. For example, a system, e.g., the system 100 depicted in FIG. 1, appropriately programmed in accordance with this specification, can perform the process 700.

The system can receive an input image (step 702).

As described with reference to FIG. 1, the input image can be any appropriate degraded image given the image restoration task.

For example, the image restoration task can be super resolution and the input image can be a low-resolution image.

As another example, the image restoration task can be denoising and the input image can be a noisy image.

As another example, the image restoration task can be deblurring and the input image can be a blurry image, e.g., an image that includes one or more blurring artifacts.

As another example, the image restoration task can be inpainting and the input image can be an image that includes missing or damaged areas.

The system can obtain, for each of multiple modalities, a respective context input belonging to the modality and characterizing the input image (step 704).

As described above with reference to FIG. 1, the image restoration system can extract multiple modalities from the input image.

The multiple modalities can be any appropriate modality that characterizes an image. For example, the multiple modalities can include a text modality, and one or more spatial modalities. In some implementations, two or more of the modalities are respective spatial modalities. The spatial modalities can include one or more of: a depth modality, a segmentation modality, an edge modality, a pose modality, or any other appropriate spatial modality.

The system can then obtain, for each of the multiple modalities, the respective context by processing the input image using one or more respective image processing neural networks.

For example, the context input of the text modality is a text prompt describing (i) the input image, (ii) the restored image, or (iii) both. For example, the system can obtain the text prompt (e.g., the context input of a text modality) by processing the input image using an image captioning neural network to generate the text prompt.

In some implementations, the context inputs of the spatial modalities include a respective set of one or more values for each of a plurality of spatial regions in the input image 105.

In some implementations, the context inputs of the spatial modalities include a respective set of one or more values for each pixel of a plurality of pixels in the input image 105.

As another example, the context input of a segmentation modality is a segmentation map over the input image. The segmentation map can be any appropriate segmentation map, including a semantic segmentation map, an instance segmentation map, or a panoptic segmentation map. In some implementations, the image restoration system can process the input image using an image segmentation neural network to generate the segmentation map.

As another example, the context input of an edge modality is an edge detection map that identifies edges in the input image. In some implementations, the image restoration system can process the input image using an edge detection neural network to generate the edge detection map.

As another example, the context input of a depth modality is a depth map over the input image 105. In some implementations, the system can process the input image using a depth estimation neural network to generate the depth map.

The system can perform an image restoration task on the input image by generating a restored image from the input image using an image restoration neural network that is conditioned on the respective context inputs for the plurality of modalities (step 706).

As described in FIGS. 1, 3, and 4, the system can process the context inputs of the modalities using one or more encoders and a multi-modal token processing neural network to generate a set of multi-modal tokens on which to condition the image restoration neural network. The system can process the input image and the set of multi-modal tokens to generate a restored image using the image restoration neural network.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are corresponded to in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes corresponded to in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving an input image;
obtaining, for each of a plurality of modalities, a respective context input belonging to the modality and characterizing the input image; and
performing an image restoration task on the input image by generating a restored image from the input image using an image restoration neural network that is conditioned on the respective context inputs for the plurality of modalities.

2. The method of claim 1, wherein the plurality of modalities include a text modality and the context input of the text modality is a text prompt describing (i) the input image, (ii) the restored image, or (iii) both.

3. The method of claim 2, wherein obtaining, for each of a plurality of modalities, a respective context input belonging to the modality and characterizing the input image comprises:
processing the input image using an image captioning neural network to generate the text prompt.

4. The method of claim 1, wherein two or more of the modalities are respective spatial modalities.

5. The method of claim 4, wherein the two or more spatial modalities comprise at least two of: (i) a segmentation modality, (ii) an edge modality, and (iii) a depth modality, wherein the context input of the segmentation modality is a segmentation map over the input image, the context input of the edge modality is an edge detection map that identifies edges in the input image, and the context input of the depth modality is a depth map over the input image.

6. The method of claim 1, wherein obtaining, for each of a plurality of modalities, a respective context input belonging to the modality and characterizing the input image comprises:
processing the input image using a respective neural network to generate the respective context input, wherein the respective neural network is one of: (i) an image segmentation neural network, (ii) an edge detection neural network, and (iii) a depth estimation neural network.

7. The method of claim 1, wherein generating a restored image from the input image using an image restoration neural network that is conditioned on the respective context inputs for the plurality of modalities comprises:
processing the respective context inputs for the plurality of modalities to generate a conditioning input; and
generating a restored image from the input image by processing the input image and the conditioning input using the image restoration neural network.

8. The method of claim 7, wherein processing the input image and the conditioning input using the image restoration neural network comprises:
initializing a representation of the restored image;
at each of a sequence denoising steps:
generating a denoising output for the denoising step, comprising processing a first input comprising the representation of the restored image, a representation of the input image, and the conditioning input using the image restoration neural network to generate a first denoising output; and
updating the representation using the denoising output; and
after a last denoising step in the sequence, generating the restored image from the representation of the restored image.

9. The method of claim 8, wherein the first input further comprises a positive text prompt, and wherein generating a denoising output for the denoising step comprises:
processing a second input comprising a negative text prompt, the representation of the restored image, the representation of the input image, and the conditioning input using the image restoration neural network to generate a second denoising output; and
generating the denoising output by combining the first and second denoising outputs in accordance with a guidance weight for the denoising step.

10. The method of claim 7, wherein processing the respective context inputs for the plurality of modalities to generate a conditioning input comprises:
for each modality, processing the respective context input of the modality using a respective encoder neural network to generate a set of tokens representing the respective context input of the modality; and
processing an input comprising the sets of tokens for the modalities using a multi-modal token processing neural network to generate the conditioning input.

11. The method of claim 10, wherein processing an input comprising the sets of tokens for the modalities using a multi-modal token processing neural network to generate the conditioning input, comprises:
applying an attention mechanism to the sets of tokens for the modalities.

12. The method of claim 10, wherein processing an input comprising the sets of tokens for the modalities using a multi-modal token processing neural network to generate the conditioning input, comprises:
applying a cross attention mechanism between the sets of tokens for the modalities and a sequence of learnable latent tokens.

13. The method of claim 12, wherein influence of the one or more modalities on the restored image is controlled to selectively amplify or suppress the influence of specific modalities of the one or more modalities in the multi-modal token processing neural network.

14. A system comprising one or more computers and one or more storage devices that are operable, when executed by the one or more computers, to cause the one or more computers to perform operations comprising:
receiving an input image;
obtaining, for each of a plurality of modalities, a respective context input belonging to the modality and characterizing the input image; and
performing an image restoration task on the input image by generating a restored image from the input image using an image restoration neural network that is conditioned on the respective context inputs for the plurality of modalities.

15. The system of claim 14, wherein the plurality of modalities include a text modality and the context input of the text modality is a text prompt describing (i) the input image, (ii) the restored image, or (iii) both.

16. The system of claim 14, wherein two or more of the modalities are respective spatial modalities.

17. The system of claim 16, wherein the two or more spatial modalities comprise at least two of: a segmentation modality, (ii) an edge modality, and (iii) depth modality, wherein the context input of the segmentation modality is a segmentation map over the input image, the context input of the edge modality is an edge detection map that identifies edges in the input image, and the context input of the depth modality is a depth map over the input image.

18. The system of claim 14, wherein generating a restored image from the input image using an image restoration neural network that is conditioned on the respective context inputs for the plurality of modalities comprises:
processing the respective context inputs for the plurality of modalities to generate a conditioning input; and
generating a restored image from the input image by processing the input image and the conditioning input using the image restoration neural network.

19. The system of claim 18, wherein processing the respective context inputs for the plurality of modalities to generate a conditioning input comprises:
for each modality, processing the respective context input of the modality using a respective encoder neural network to generate a set of tokens representing the respective context input of the modality; and
processing an input comprising the sets of tokens for the modalities using a multi-modal token processing neural network to generate the conditioning input.

20. A computer storage medium encoded with instructions that, when executed by one or more computers, cause the one or more computers to perform operations comprising:
receiving an input image;
obtaining, for each of a plurality of modalities, a respective context input belonging to the modality and characterizing the input image; and
performing an image restoration task on the input image by generating a restored image from the input image using an image restoration neural network that is conditioned on the respective context inputs for the plurality of modalities.
